(19) United States
(12) Patent Application Publication
(10) Pub. No.: US 2009/0240751 A1
(43) Pub. Date: Sep. 24, 2009

(54) Text-based calculator for dimensional computations

(76) Inventors: Anthony A. Renshaw, New York, NY (US); Carl Edward Renshaw, Hanover, NH (US)

Correspondence Address: Anthony A. Renshaw, PO Box 20327, New York, NY, 10021, US

(21) Appl. No.: 12/381,539

(22) Filed: Mar. 12, 2009

Related U.S. Application Data
(60) Provisional application No. 61/070,513, filed on Mar. 24, 2008.

(51) Int. Cl. G06F 15/02; G06F 3/00; G06F 3/048

(52) U.S. Cl. 708/131; 715/770; 708/164; 715/804

(57) ABSTRACT

The present invention relates to tools that handle and perform computations using dimensional and dimensionless values, automatically converting them appropriately within equations, outputting answers in default or user-selected output units, and indicating when inconsistencies or errors are present in the input so that these can be quickly and easily identified and immediately corrected. More particularly, it relates to improved, computer-based systems, methods and software for automatically changing between different units, correctly computing formulas using dimensional values, and outputting the results in arbitrary dimensionally consistent units. The current embodiments accomplish these objectives with as much simplicity, as flexible a syntax, as little typing, and with as little chance of human error as possible.

The present application claims the benefit of U.S. Provisional Application Ser. No. 61/070,513 filed Mar. 24, 2008 which is incorporated by reference herein in its entirety.

### FIELD OF INVENTION

The present invention relates to tools for both: (1), converting dimensional quantities from one set of units to another quickly and efficiently; and (2), correctly and automatically performing mathematical computations using dimensional and dimensionless quantities, variables, and functions. More particularly, it relates to improved, computer-based systems, methods and software for: (1), performing mathematical calculations with both dimensional and dimensionless quantities; (2), allowing extensive flexibility and customization so that both the user input and the computer output use the units that are most useful and convenient for the user with all other required unit conversions performed correctly by the computer; and (3), providing meaningful error messages and feedback to the user so that he or she can edit, correct, alter, and improve a set of calculations with as little chance of human error as possible. The current embodiments accomplish these goals with as much simplicity as possible so that use of the tool is as quick, easy, and error free as possible.

### BACKGROUND OF THE INVENTION

In numerous human endeavors and quantitative fields, mathematical calculations are performed on both dimensional and dimensionless values. These necessary and fundamental calculations include converting values from one kind of units to another. For example, as the global economy expands, there is an urgent need to be able to convert from the United States Customary System of Units (inches, feet, pounds, etc.; also known as English units) to equivalent metric units such as meters, kilograms and Newtons. It also includes a vast number of calculations using dimensional values in order to calculate area, volume, mass, weight, and the like. Such computations are required for purposes ranging from shipping and transport to sophisticated engineering calculations needed for the design, construction, as well as testing of complex machines such as airplanes and advanced medical devices.

In all of these situations, there is a pressing need to perform the calculations quickly, efficiently, and accurately. The cost of inaccurate calculations can be considerable. For example, in 1999, NASA's Mars Climate Orbiter, part of a 125 million dollar planetary exploration program, crashed into the planet Mars. In the subsequent investigation, it was determined that the primary cause of the crash was incorrectly converting the engine's impulse from English to metric units.

For units conversion, there are reference texts, online unit converters, and stand-alone computer programs that users can purchase and use. Use of these tools is time consuming and error-prone. For dimensional calculations, there are expensive computer software programs that will perform specific computations within their software. This software and its proprietary data formats are not readily accessible to the public and do not allow collaboration between groups of people unless they all have access to the same platform.

Consequently, despite the wide spread availability of related computer tools, a substantial proportion of dimensional computations are still performed manually. Many introductory undergraduate engineering textbooks give numerical problems that are substantially exercises in changing from one unit to another. See, for example, J. A. Wickert, An Introduction to Mechanical Engineering (Second Edition), Nelson-Thomson Learning, 2005. While the time and effort expended on such exercises can be valuable pedagogically for familiarizing students with different kinds of units, the actual process of conversion is dreary, tedious, and error-prone.

Other textbooks include example problems that are done twice: once in metric units, and then, immediately thereafter in the text, the same problem entirely in English units. See, for example, R. E. Sonntag, C. Borgnakke, and G. J. Van Wylen, Fundamentals of Thermodynamics (Sixth Edition), John Wiley & Sons, 2003. Again, such writing may serve a pedagogical purpose in familiarizing students with how dimensional computations may be performed using two different unit systems. But it is tedious and error-prone. Furthermore, there is an implicit message in this kind of presentation that all computations need to be performed exclusively and entirely in one set of units (e.g., metric or English). While it may be that people are less likely to make a manual mistake if all values are in the same unit system, there is no inherent reason why any set of calculations need be done using the same unit system for all input quantities. A well designed computer tool would not require all values in the same unit system.

Consequently, there is a need for tools that enable students and professionals to quickly, efficiently, and correctly convert numerical quantities from one set of units to another.

There is also a need for tools that can take input values in any units and compute a formula correctly whose output can be displayed in any consistent units without having the user perform or program any of the conversions. There is a need for the computer to provide information when there are any mistakes or inconsistencies in the input, the formula, or the output units so that these can be quickly corrected. Such a computer-based method or system would help prevent costly errors related to dimensional computations and the conversion of dimensional units.

There is a need for a tool that will check dimensional formulas and equations for dimensional consistency.

There is also a need for a tool that is inexpensive and easy to use.

A convenient platform for such computer based tools would be a web-based tool accessible from the Internet. Such a tool would be inexpensive to access, and can provide the needed form of input and user feedback. Another platform would be a stand-alone software program that could be run on a computer.

Existing tools and methods for assisting people when converting dimensional units and performing dimensional computations are inadequate.

There are several computer software programs that permit sophisticated computations with dimensionless values. These include Mathematica, Maple, and Matlab. These tools are powerful computational calculators with numerous sophisticated mathematical functions and tools. However, these tools cannot directly perform dimensional calculations. Of course, numbers with dimensional interpretations can be input into these programs, but the user is responsible for correctly converting any answers and for ensuring the dimensional consistency of the calculations performed. There is no feedback in these programs for dimensional errors as the programs have no knowledge of any dimensions.

Defects and disadvantages with these computer software programs include:
They do not handle dimensions. All values are dimensionless within the software, and all conversions and interpretations of dimensional values must be done by the user.
They are fairly expensive, and, to authors' knowledge, not written to be accessible from the Internet.

For converting dimensional units, many engineering textbooks contain tables with lists of conversion factors. These are often displayed on the inside of the book's covers for handy reference. There are also resource references that contain conversion factors and procedures for a wide range of different fields. For example, the CRC Handbooks and Desk Reference series covers fields as diverse of chemistry, physics, engineering and nutrition. Many introductory undergraduate engineering textbooks give numerical problems that are substantially exercises in changing from one unit to another. See, for example, J. A. Wickert, An Introduction to Mechanical Engineering (Second Edition), Nelson-Thomson Learning, 2005.

These reference materials require users to perform conversions manually. Thus, all results using these materials are subject to human error. Furthermore, the manual conversion is tedious and time consuming. In addition, once a user has performed the conversion, these tools do not assist in any computations or calculations using the results.

Defects and disadvantages with standard reference materials include:
All conversions must be performed manually by the user.
In order to correct any changes and errors detected in the input, the complete set of calculations following the error must be re-done by hand.
The work is tedious and error prone.
The reference textbooks books must be located and obtained.
The reference textbooks do not perform any computations.

Computer-based tools are also available for converting dimensional units. Numerous websites provide tools in which the user can choose various pre-programmed units from pull down menus in order to convert from one unit to another. One example of such a site can be found at www.onlineconversion.com.

These software tools can be helpful. However, the conversions that can be performed are limited to the units that are on the pull down menus or that are programmed into the software function. If a user has any unusual set of units, such as the case where metric and English units are mixed together, the pull down menus or software functions are unlikely to have the required conversion. Furthermore, the process can still be quite tedious, especially if more than one conversion is required. And, as with the printed references, once the conversion is performed, the user is still required to perform the calculations him or herself.

Defects and disadvantages with these online unit conversion tools include:
These tools only perform units conversion. They do not perform computations based on dimensional equations. They do not check for dimensional consistency of any equations.
The user is limited to the units in the program which is a relatively small set of possible units. If the program does not have the units needed, the program is of no help.
They are tedious and error prone.
The can involve numerous mouse clicks and/or typing to input and convert units.

Microsoft Excel can convert units (using the software function “Convert” located in the Analysis ToolPak add-in). Once Excel has converted units, then the user can program various dimensional calculations using the results. However, Microsoft Excel does not perform any consistency checks on the calculations, so, once again, the accuracy of the result is subject to human error. In addition, Microsoft Excel has a number of other drawbacks. For combinations of units, the units must be converted one after another rather than all at once. This is tedious and error prone. Second, since the calculations are embedded in Microsoft Excel Worksheets, they are not immediately visible to the user and debugging them is tedious and error prone. Third, since the conversion tool is very simple, it often gives incorrect answers. For example, to convert temperature from 212 degrees Fahrenheit to degrees Celsius, the function call is CONVERT(212, “F”, “C”), which correctly gives the answer of 100. However, if the user tries to embed a calculation such as converting the difference of 212 degrees Fahrenheit and 32 degrees Fahrenheit to degrees Celsius using the function call CONVERT(212−32, “F”, “C”), the answer returned is 82.22. In this case, the computation performed by the computer is ((212−32) degrees Fahrenheit)=(212 degrees Fahrenheit)=82.2 degrees Celsius. However, it may not, and, most likely, is not what the user intended. Since 212 degrees Fahrenheit=100 degrees Celsius and 32 degrees Fahrenheit=0 degrees Celsius, the user may have wanted to obtain the result ((212 degrees Fahrenheit)−(32 degrees Fahrenheit))=((100 degrees Celsius)−(0 degrees Celsius))=100 degrees Celsius. In this case, the unwieldy syntax used by Microsoft Excel's Convert function may have caused an unintentional units conversion error.

Defects and disadvantages with Microsoft Excel Convert function include:
It is easy to make fundamental mistakes, such as the temperature error just described.
All conversions must be done separately. For a single dimensional value that has many base units in its dimension, this may require multiple calls to the CONVERT function.
It is tedious and error prone.
Although Excel has the ability to program equations and formulas, it does not have the ability to check these equations for dimensional consistency. This is a tremendous limitation.
The equations and formulas are typically not visible in the worksheet without selecting (clicking on) one of the cells. This makes it difficult to read and debug the equations.

Octavian Micro Development Inc. (see www.octavian.com/excel.html) provides a unit conversion tool in the form of an Excel addin. Unfortunately, this tool suffers a number of disadvantages. The syntax chosen is cumbersome in that all compound units must be separated by the multiplication character ‘*’ and the division symbol, ‘/’, is not recognized. As a result, the input symbols are significantly different than customarily encountered. For example, rather than expressing velocity as “m/s”, one must type “m*ŝ−1”. This is significantly more typing and much more difficult to read and interpret. Furthermore, this tool does not have a separate unit to represent a relative difference in temperature. Taken together, these are major limitations.

Defects and disadvantages with these kinds of existing units conversion tools include:
They do not accept equations or allow equations to be checked for dimensional consistency.
The syntax for inputting unit expression is too restrictive, requiring too much user typing, and does not replicate the way units are normally read or written.

There are also many large Computer-Aided Design programs that can perform a limited subset of dimensional conversions and calculations. For example, there is the Pro/ENGINEER program distributed by Parametric Technology Corp (PTC). There is the SolidWorks program sold by SolidWorks, Inc. These large software platforms allow engineers to design mechanical and electronic products in a virtual environment (i.e., on the computer) and perform specific calculations on the designs. For example, in the mechanical design platforms, tolerances, size, and mass calculations can be performed in either English or metric units. Different parts can be mated to ensure that they fit together properly. These and other tools can be valuable to large engineering and manufacturing firms. However, these software packages are very expensive. In addition, the calculations they can perform are limited only to specific pre-programmed calculations that the programmers considered important for the kinds of parts being designed. They do not represent a flexible environment for doing a wide range of dimensional calculations.

Defects and disadvantages with large Computer-Aided Design programs include:
These are extremely specialized tools. Typically, they allow a design to be fully converted from one system of units to another, but do not let the user pick and choose the units for any particular output. The calculations are limited to those programmed in the software.
The user cannot program arbitrary dimensional equations into these tools.
These are expensive and not executable from the Internet.
Typically, these tools require extensive user training.

The internet search website Google can be used to convert units by typing the conversion into the text box of the search engine. The tool can also be used for mathematical calculations. For example, to convert the sum of 2 inches and 5 feet into meters, simply type “2 inch+5 feet in m” into the search engine text box. (Google uses the keyword “in” to indicate that units conversion is desired. “in” also is the abbreviation for “inch”, which can be confusing.) The result displayed is then: “(2 inch)+(5 feet)=1.5748 meters”. However, this tool has several disadvantages. There is no feedback when the user makes a mistake. If Google decides that the input is not a calculation, then Google assumes that the input is a search request and returns a list of internet websites that are superficially related to the input text. That is, Google interprets the input text as a search request, not a unit conversion. It does not indicate in any way why the statement is not interpreted as a calculation. The tool does not recognize many common unit abbreviations such as rps and rpm. Furthermore, the input is limited to one line, and it does not handle variable names, vectors, or user defined functions. And, like Microsoft Excel, it makes errors. For example, if one inputs “212 degrees F.−32 degrees F. in degrees C.”, the result is “(212 degrees Fahrenheit)−(32 degrees Fahrenheit)=−173.15 degrees Celsius”, which is incorrect.

There is another problem with the Google calculator: you cannot do multiple conversions at once. If you type “1 in in ft”, you get the correct answer: “1 in=0.0833333333 feet”. However, if you try to convert it simultaneously into both feet and meters by entering “1 in in ft in m”, you do not get a conversion results. Instead, you are directed to the search engine results.

Defects and disadvantages with the Google calculator include:
It does not allow the user to input more than one line. The line cannot contain more than one conversion or specified output dimensions. The input cannot contain variable names. This restricts this tool to very simple computations.
It does not allow variables, vectors, or user-defined functions.
When the user uses an unexpected or unknown unit, or when the user makes a mistake in the input, no error message is given indicating the nature of the error. Instead, a Google search request is performed. This makes it hard to debug and create an input that will do the calculation desired.
As documented above, some of the answers are not correct.
Often, the user must guess what units will be recognized. Google does not provide a comprehensive list of units recognized.
Many of the units require a great deal of typing.

Another software tool for performing dimensional calculations is MathCad, distributed by Parametric Technology Corp. This tool allows users to set up a MathCad worksheet which displays, either on the computer screen or in a print out, the computational work of the user. The worksheet can include equations with dimensional values in it. When the equation is dimensionally inconsistent, there is feedback requesting that the inconsistency be corrected. When any input values are changed, the complete set of computations on the worksheet is updated automatically. However, this tool also suffers from a number of deficiencies. First, the tool is expensive. Second, the tool converts all input into non-ASCII, XML-based, graphical formats. While such formats look nice, they limit the ease with which results can be edited and shared with other people. The results are stored in a proprietary XML format that is only readable by other MathCad users. This has the advantage of allowing users to embed graphics and text into their worksheets. However, it makes it hard to share the work with other people, since the work is only readable by computers that have MathCad installed. In addition, using the tool requires learning special key strokes in order to input equations properly in their proprietary software environment, as well as learning special conventions for when a result is bound to an input line. For example, the user must learn that a space is used to finish input of the denominator of a fraction.—in fact, a space may need to be input multiple times to get the cursor to the correct location when editing. Such strategic use of the space key and other special key strokes and mouse clicks is annoying and can make the program difficult to learn. In addition, special non-ASCII symbols must often be used. For example, relative temperature is indicated by ΔT. Greek letters can be used, but to use them, they must be selected from pull down menus, which is tedious. Also, since the program also allows text and graphics to be placed in the worksheet, there are numerous menus that users must learn how to use and navigate within before he or she can use the tool.

Defects and disadvantages with MathCad include:
The output can only be expressed in one set of units. You cannot have the output expressed in two different units based on the same input value except by repeatedly outputting the same value.
It is expensive and not Internet deployable.
The user must learn a number of specialized key strokes and syntax in order to properly use the tool. For example, the user must know that if you delete one parenthesis, MathCad deletes its matching pair. This may not be what the user expects, especially when the user is editing input. The user must learn special symbols and base units such as ΔT.
All input is converted into graphics that look much like equations in textbooks. This conversion involves the program taking the input keystrokes and mouse clicks from the user, converting these into an XML format, and then writing an independent graphical representation of the XML which is displayed to the user. Therefore, the actual user input is not the same as the output on the screen that the user sees. This has a number of disadvantages. (1) You have to know special keys to correctly input equations. (2) It can require multiple key strokes to correctly edit input. Editing is tedious. Inputting can involve many mouse clicks on menus. This can be laborious and time consuming. (3) The input and output cannot be easily shared with collaborators and colleagues. If the XML is shared, this can only be readily interpreted by someone with access to MathCad. If a screen shot or printout of the results is shared, then this cannot be easily entered into the program for editing and recalculation.

The lack of easy to use, inexpensive tools for performing dimensional computations has resulted in a strange phenomenon in the way that undergraduate engineering is taught. Despite the fact that most undergraduate engineers possess their own computers, most students still perform engineering calculations involving units such as those assigned for homework manually. They do not use conversion tools, but still write down input values on a sheet of paper, convert then with a hand held calculator, and then do the homework problem with the calculation. While this approach may have some pedagogical value, it is extremely tedious and error prone. Furthermore, this procedure is implicitly encouraged by textbooks that give detailed directions on how to convert units in order to properly perform dimensional computations. Such pedagogical procedures would not be necessary or, perhaps even tolerated, if a readily accessible tool were available for automatically and correctly performing dimensional computations.

Therefore, there is a need for an inexpensive, readily accessible, easy to use tool that is less cumbersome than existing tools for performing dimensional computations and units conversion.

### SUMMARY OF THE INVENTION

The present invention is a calculator that correctly handles and performs calculations using dimensional units, automatically converting them as necessary within equations, outputting answers in user-selected default or explicit units, and indicating when inconsistencies are present in the calculations so that errors can be identified and corrected. The input and output of the invention is entirely text based. The invention allows users to define variables and use them in user-defined functions.

This specification describes the syntax, functions, and features of the tool and gives some examples of how it can be used. A more complete understanding of the present invention, as well as further features and advantages of the invention, will be apparent from the following Detailed Description and the accompanying drawings.

### BRIEF DESCRIPTION OF THE DRAWINGS

FIG. 1 shows a computer based system which may be suitably utilized to implement the present invention;

FIG. 2 shows how a sample implementation of the invention could appear on a computer, illustrating the input and output screens seen by the user.

### DETAILED DESCRIPTION

The present invention may be suitably implemented as a computer-based system, in computer software which resides on computer readable media, such as solid state storage devices, such as RAM, ROM, or the like, magnetic storage devices such as a hard disk or floppy disk media or flash memory devices, optical storage devices, such as CD-ROM or the like, or as methods implemented by such systems and software.

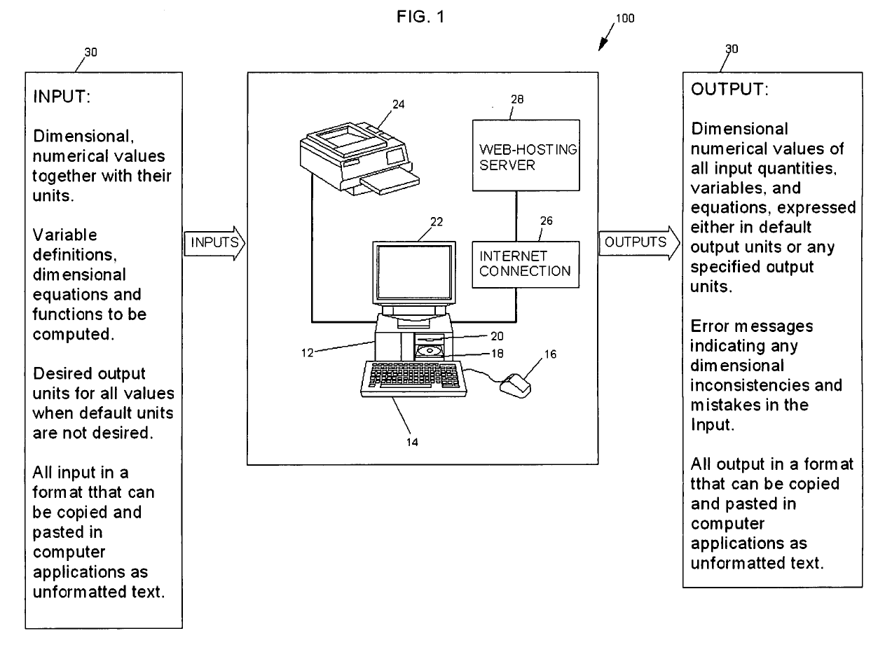

FIG. 1 shows a block diagram of a computer system 100 which may be suitably used to implement the present invention. System 100 is implemented as a computer 12, such as a personal computer, workstation, or server. One likely scenario is that the system of the invention will be implemented as a personal computer or workstation which connects to a server 28 or other computer through an Internet connection 26. In this embodiment, both the computer 12 and server 28 run software that enables the user to input dimensional calculations on the computer 12, send the input for conversion to output at the server 28, and then displays the output on the computer 12. The computer would only need an Internet browser program such as Internet Explorer or Mozilla Firefox to use the present invention. In another embodiment of the invention, the entire software is installed and runs on the computer 12, and the Internet connection 26 and server 28 are not needed. In still a further embodiment, the Internet connection is replaced with a local area network. As shown in FIG. 1 and described in further detail below, the system 100 includes software that is run by the central processing unit of the computer 12. The computer 12 may suitably include a number of standard input and output devices, including a keyboard 14, a mouse 16, CD-ROM drive 18, disk drive 20, monitor 22, and printer 24. It will be appreciated, in light of the present description of the invention, that the present invention may be practiced in any of a number of different computing environments without departing from the spirit of the invention. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as a Blackberry™, Treo™, or the like. The invention could also be installed entirely on a portable device such as an Apple's iPhone.

One embodiment of the invention has been designed for use on a stand-alone personal computer running either Windows (Microsoft 2000, XP, or Vista) or Macintosh operating systems and accessing a web-hosting server.

According to one aspect of the invention, it is contemplated that the computer 12 will be operated by a user in an office, classroom, or study setting.

As illustrated in FIG. 1, and as described in greater detail below, additional inputs 30 may suitably include dimensional, numerical values together with their units, variable definitions, dimensional equations, and functions to be computed, and any desired output units for all values where default output units are not desired.

As further illustrated in FIG. 1, and as described in greater detail below, the system outputs 32 may suitably include dimensional numerical values of all input quantities and variables, and equations, expressed either in default output units or any specified output units, and error messages indicating any dimensional inconsistencies and mistakes in the input.

The output information may appear on the monitor 22 or may also be printed out at the printer 24. The output information may also be electronically sent to an intermediary for interpretation. Other devices and techniques may be used to provide outputs, as desired.

In addition, both the input and output can be copied and pasted into different software objects on the computer 12. In the Windows operating system, for example, once either the input or output text has be highlighted using the mouse 16, typing Control-C on the keyboard 14 will copy the input or output onto the computer's software clipboard. The input or output can then be pasted into a file or email using the Control-V key stokes. This copying and pasting functionality of the input and output is one of the principal advantages of the present invention.

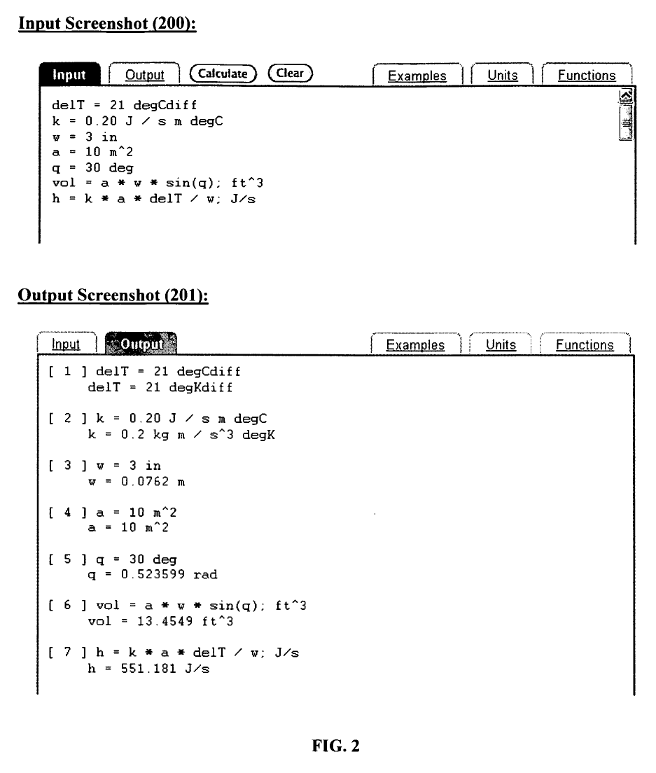

FIG. 2 shows a sample implementation of the invention. The Figure includes a screenshot 200 from a computer of the input screen seen by the user. In this example, the user has typed seven input lines of text into the input window. These are the dimensional calculations the user wishes to compute. The syntax of the input text lines will be described later in detail. In this screen, there is also a “Calculate” button. When the user clicks on the “Calculate” button, the input text is submitted to the computer for calculation. The screen then automatically changes to the output screen shown in 201. Here the computer gives text output the repeats the input lines along with the results of the calculations performed by the computer listed immediately after each input line.

With this background in mind, we turn to a detailed discussion of a presently preferred embodiment of the invention and its context.

This invention is a calculator that correctly handles and performs calculations using dimensional units, automatically converting them appropriately within equations, outputting answers in user-selected default or explicit units, and indicating when inconsistencies are present in the input so that errors can be identified and corrected.

This tool was created so that engineering and physics problems need not be “solved by hand”, as still frequently occurs in school and in the professional workplace. The goal was to design a tool that would do this work automatically, so that the only way for an error to occur was to enter the wrong initial values or use the wrong equation. Everything else—all unit conversion, verification of dimensional consistency, and, of course, the actual calculations—would be handled correctly by the computer. This makes the invention as easy as possible to use and as hard as possible to make a mistake.

Key features and advantages of this invention are:
It is accessible to anyone with Internet access.
The user enters equations and units the same way he or she would write them or read them in a textbook. There are no special key strokes or mouse clicks, and as little syntax to learn as possible.
Apart from specifying the dimensions of any input parameters and requesting any special output dimensions to use, the user does not need to worry about dimensions. The invention automatically correctly handles all necessary conversions of units.
Whenever there are mistakes or dimensional inconsistencies, the invention provides a clear error message, so the user can quickly go back to the input window, fix the mistake, and calculate the correct answer. The ability to preserve the original input so that it can be readily edited and re-submitted to be processed is one of the key features of the present invention.
All input and output is (ASCII) text-based, so it can easily cut, paste, and shared with collaborators and colleagues.
The typing required has been minimized as much as possible. This makes the invention as fast and easy to use as possible, as well as making it easy to learn.

Unlike many on-line tools for converting units, this invention is entirely text-based. You type the units you want exactly as you would write them down; there are no pull down menus to select types of units or units themselves. You do not have to learn any special key strokes or escape sequences to enter input into the invention. You can do calculations in the most convenient units—normally the ones you are given—rather than having to convert them to an arbitrary standard system.

This invention allows units to be expressed as simple combinations of pre-programmed base units expressed with a flexible syntax. For example, this invention interprets “m/ŝ2”, “m/s/s”, “m ŝ−2”, “m/s s” , “m/s*s”, and “m/(s s)” as equivalent units for acceleration and “slug*m/ŝ2” as a force, even though it combines metric and English units.

You cannot make mistakes converting units because you never need to convert any units at all. The computer does all conversions. Furthermore, because the input is text-based, you can easily copy, paste, and exchange your work. You do not have to input your work into a special window that “formats” your input. You do not have to learn special key strokes. You format your input the way you like it.

This invention gives detailed error messages when your input is incorrect or inconsistent. If you request the output in units that are not compatible with the value calculated, this invention lets you know. It is difficult to make a mistake in your work and not realize it.

This invention allows you to define variables, and then use them in functions. You can solve nonlinear equations or optimize an objective function. A large library of standard math functions is included. This simplifies the process of engineering design, where the same set of calculations must be done iteratively to determine acceptable values. Unlike programs like Microsoft Excel, the equations are clearly visible in the input and output, so you can easily check your work, spot mistakes and correct them.

The following gives a detailed description of the invention syntax and capabilities.

As shown in FIG. 2, the fundamental components of this invention are the input window under the Input Tab that can be filled with one or more lines of ASCII text, a “Calculate” button that submits the text in the input window to the invention, and an output window of text under the Output tab which displays the results of all the conversions and calculations in the units requested by the user. The invention also has a “Clear” button to clear any input from the input window so that new calculations can easily be started.

Except for user defined functions and some special commands to set options (see below), each line in the input file returns a value, which may be dimensionless or dimensional. To convert the output value into other units, simply list the units desired at the end of the line separated from the input value by a semicolon. The line can end in any number of different requested output units, each separated by semicolons.

For example, suppose we want to convert one inch into meters. The input and output (returned after hitting the “Calculate” button) would be the following:

TABLE 1
Converting one inch to 0.0254 meters.

| | |
|---|---|
| Input Text: | 1 inch; meter |
| Output Text: | [ 1 ] 1 inch; meter = |
| | 0.0254 meter |

This invention numbers the input lines and repeats the input after the line number in the output. The next line then lists the output requested. This makes it easy to follow the output.

To simultaneously see what one inch is in meters, millimeters, feet, yards, and miles, simply append each of these units one after the other, each separated by semicolons. This invention recognizes the standard abbreviations for most units.

TABLE 2
Simultaneously converting one inch to several different units of length.

| | |
|---|---|
| Input: | 1 in; m; mm; km; ft; yard; mile |
| Output: | [ 1 ] 1 in; m; mm; km; ft; yard; mile = |
| | 0.0254 m = 25.4 mm = 2.54e−005 km = 0.0833333 ft = |
| | 0.0277778 yard = 1.57828e−005 mile |

If you do not have a preference for the output, you don't have to request any. When no output units are requested, the output is given in the default unit system, which starts as meter-kilogram-second (MKS).

TABLE 3
Converting one inch to the default output units.

| | |
|---|---|
| Input: | 1 in |
| Output: | [ 1 ] 1 in = 0.0254 m |

If you request an output unit that is incompatible with the dimensional value, an error message is printed and the value is given in the default units.

TABLE 4
When the requested units are incompatible, an error message is given
and the output value is displayed using the default units.

| | |
|---|---|
| Input: | 1 in; kg |
| Output: | [ 1 ] 1 in; kg |
| | ERROR IN REQUESTED OUTPUT: ‘kg’ is |
| | incompatible. = 0.0254 m |

Similarly, if you request an output unit that is not recognized by the invention, an error message is printed out and the value is given in the default units.

TABLE 5
When the requested output units are not recognized, an error message
is given and the output value is displayed using the default units.

| | |
|---|---|
| Input: | 1 in; widgets |
| Output: | [ 1 ] 1 in; widgets |
| | ERROR IN REQUESTED OUTPUT: ‘widgets’ not |
| | recognized. = 0.0254 m |

Because the Input and Output windows are saved separately, it is easy to go back to the Input text and correct any errors that are indicated or alter the problem. The revised input can then be re-submitted by hitting the Calculate button.

This invention recognizes four standard default unit systems:
MKS: meter-kilogram-second
cgs: centimeter-gram-second
IPS: inch-pound-second
FPS: foot-pound-second
   (The pound in IPS and FPS is lbf, not lbm). To use any of these systems, simply input in the system name. For example, to display different dimensional values using foot-pound-seconds (FPS), type:

TABLE 6
Output using the FPS (foot-pound-second) default system.

| | |
|---|---|
| Input: | FPS |
| | 1 cm |
| | 1 kg |
| | 1 N |
| Output: | [ 1 ] FPS |
| | Default units = FPS with 0 exceptions. |
| | [ 2 ] 1 cm = 0.0328084 ft |
| | [ 3 ] 1 kg = 0.0685218 lbf s\hat{ }2 / ft |
| | [ 4 ] 1 N = 0.224809 lbf |

In this example, each of the four input lines has a separate, numbered output line. In line 3, one kilogram (kg) is converted to lbf ŝ2/ft, which is the default units for mass in the FPS system.

In the above example, the output associated with the first input line, “FPS”, is “Default units—FPS with 0 exceptions.” Often, users want to define certain default output units to override the defaults. For example, the standard measurement of angle in all systems is radians, but often the user wants the output in degrees. Or, when analyzing mechanical moments, it can be preferable to display the output in “N m” rather than “kg m̂2/ŝ2”. When analyzing energy, it may be preferable to display the output in “J” rather than either “kg m̂2/ŝ2” or “N m”, all of which are equivalent. To set exceptions to the default output units, simply list them in between the parentheses following the default unit system, separated by commas.

Some of the common default exceptions are:
MKS(deg), cgs(deg), FPS(deg), IPS(deg),
MKS(N, N m, N/m, rpm, kW)
MKS(N, J)
MKS(degC), IPS(degF)
MKS(degC, J/kg degC)
FPS(rpm, hp)

You can also use the MKS, cgs, IPS, and FPS as output units to force DimensionEngine to output a value in terms of the base units for each of these systems. This allows you obtain the output both in the units you want and listed using the base units of a common system of units on a single line of input. For example,

TABLE 7
Explicitly requesting default output units.

| | |
|---|---|
| Input: | 1 N; N; MKS; cgs; IPS; FPS |
| Output: | [ 1 ] 1 N; N; MKS; cgs; IPS = |
| | 1 N = 1 kg m /s\hat{ }2 = 100000 g cm /s\hat{ }2 = 0.224809 lbf |

When exceptions to the default output units are set (or reset), this invention goes through the list of exceptions, in order, to see if they are equivalent to the dimensions of the line's output value. If it is, then, that set of units is used to display the output. If no matches are found in the list of exceptions, the default units are used. (Since the exceptions are tested in order and stops as soon as a match is found, the statement “MKS(cm, mm)” is equivalent to “MKS(cm)”.)

Since this invention parses the text of any units, it has no trouble interpreting mixed and non-standard combinations of units, either in the input or in the requested output. For example,

TABLE 8
Input and output using mixed and non-standard unit combinations.

| | |
|---|---|
| Input: | 2 slug m / hr\hat{ }2; N; lbf; g in / min\hat{ }2 |
| Output: | [ 1 ] 2 slug m / hr\hat{ }2; N; lbf; g in / min\hat{ }2 = |
| | 2.25215e−006 N = 5.06302e−007 lbf = 319.202 g in / min\hat{ }2 |

You can always enter any values in the units in which you originally have them. There is no need to convert units. In fact, it is advisable NOT to convert any units, since that increases the chances of an error occurring.

This invention uses line-based, text input. The comment character is “#”. This can occur anywhere in a line, and the rest of the line is treated as a comment that is displayed in the Output Window as part of the input line, but does not affect any computation. The line continuation character is “\”. Blank lines can occur anywhere in the input text, and are often used to make the input easier to read. For example,

TABLE 9
Examples using comments (#), line continuation (\), and blank lines.

| | |
|---|---|
| Input: | # The comment character is # |
| | # Here is a an example of mixed units |
| | 2 slug m / hr\hat{ }2; N # the answer should be 2.25215e−006 N |
| | # The line continuation character is \ |
| | # Here is a single input line typed on two input lines |
| | 9.8 m \ |
| | s\hat{ }2 |
| Output: | # The comment character is # |
| | # Here is a an example of mixed units |
| | [ 1 ] 2 slug m / hr\hat{ }2; N # the answer should be 2.25215e−006 |
| | N = 2.25215e−006 N |
| | # The line continuation character is \ |
| | # Here is a single input line typed on two input lines |
| | [ 2 ] 9.8 m \ |
| | s\hat{ }2 = 9.8 m s\hat{ }2 |

This invention is more than just a tool for converting units. This invention is a calculator that automatically, consistently, and appropriately converts units within mathematical expressions to produce the correct output and give the user clear error messages when mistakes and inconsistencies are found. In other words, this invention performs dimensional computations.

The simplest example of this capability is adding, subtracting, multiplying, and dividing dimensional values. Simply type these in and this invention will correctly compute the results and display it in either the requested or default output units.

TABLE 10
A simple, dimensional calculation.

| Input: | 3 cm * 5 in + 10 ft\hat{ }2 | |
|---|---|---|
| Output: | [ 1 ] | 3 cm * 5 in + 10 ft\hat{ }2 = |
| | | 0.93284 m\hat{ }2 |

It is often easier to define a variable for a dimensional value rather than type out its dimensional value every time it is used. This is especially true when the calculation is long, or when the same dimensional value is used many times. This invention uses the “=” character to define variable names for dimensional values which can then be used in dimensional calculations. For example, the above example can be written as:

TABLE 11
The simple, dimensional calculation of
the previous example using variables.

| Input: | x = 3 cm | |
|---|---|---|
| | y = 5 in | |
| | z = 10 ft\hat{ }2 | |
| | x * y + z | |
| Output: | [ 1 ] | x = 3 cm |
| | | x = 0.03 m |
| | [ 2 ] | y = 5 in |
| | | y = 0.127 m |
| | [ 3 ] | z = 10 ft\hat{ }2 |
| | | z = 0.92903 m\hat{ }2 |
| | [ 4 ] | x * y + z = |
| | | 0.93284 m\hat{ }2 |

As with any programming language, this invention defines an order in which operations are performed in order to unambiguously define how to interpret mathematical expressions. In many programming languages, the order of operations or order of precedence is:

TABLE 12
The standard order of operators used by many programming
languages for dimensionless mathematical expressions.

Numbers, variable names, functions
Parentheses
Negation
Exponentiation
Multiplication and division left to right
Addition and subtraction, left to right

Functions include mathematical functions such as exp( ) and sin( ). The use of this order or operations is illustrated in the expression

(4+10/2)/9=(4+(10/2))/9=(4+5)/9=1

The order given matches programming languages such as Microsoft Office Excel in that negation has a higher priority than exponentiation, so −3̂2=(−3)̂2=9.

This invention adds a new operation to this list that assigns units to a dimensionless number. The full order of precedence in this invention is

TABLE 13
The standard order of operators used by this invention for
dimensional mathematical expressions.

Numbers, variable names, functions
Parentheses
Negation
Assign units to the dimensionless number immediately preceding the units
Exponentiation
Multiplication and division left to right
Addition and subtraction, left to right

Note that units can only be assigned to dimensionless numbers. Therefore, the expression

4 m

is correct and interpreted as four meters because the units “m” is assigned to the dimensionless number 4. However, the expression

(2 in+4 in)m=(6 in)m

is incorrect because evaluation of the parentheses produces a dimensional value of 6 inches, which cannot be assigned to the unit “m”. In other words, this invention does NOT interpret the expression as

(2 in+4 in)m=(6 in)m=6 in m==0.1524 m̂2

To make the syntax for this invention using the order of precedence unambiguous, we define explicitly what syntax is allowed when expressing the units that can be assigned to a dimensionless value.

Units syntax is simpler than mathematical syntax because there are fewer permissible operations. All unit expressions consist of a numerator and a denominator. The numerator and the denominator are composed of individual base units that can be raised to a power. In a units expression none of the following are allowed: variable names, functions, negation (except in the exponent), addition, or subtraction.

There are, of course, many different ways to define syntax for units expressions. This invention uses a syntax that: (a), closely matches the syntax used when people read, write, and use units; and, (b), has the least amount of typing. Sometimes, textbooks use special separators such as a dash or a dot between units that are multiplied together (m−s or m·s). These separators are not allowed in this invention.

The following rules are used to interpret unit expressions in this invention:

TABLE 14
Syntax rules for unit expressions in this invention.

Multiplication of adjacent base units is represented by a space or a “*”. Hence:
3 N m = 3 N * m
In other words, the multiplication symbol “*” is optional. This is true ONLY for the units
expression, not the mathematical expression. “3 2” is not the same as “3 * 2”.
Exponentiation is indicated by the “\hat{ }” character, as in
3 m\hat{ }2
The first division sign encountered starting from the left separates the numerator from the
denominator. All base units to the right of the first division sign are part of the
denominator, regardless of whether they are separated by division signs, spaces, or
multiplication signs. Hence:
3 kg m / s\hat{ }2 = 3 kg m / s s = 3 kg m / s / s = 3 kg m / s * s
Parentheses can be used to override the definition of the numerator and denominator syntax
rule. For example:
4 (kg m / s) s = 4 kg m
This is most helpful when the original units come in unusual numerator and denominator
pairs. As always, it is safest to enter these units as you originally have them and let the
invention convert them.
Base units exponents can only involve the division (and multiplication) of numbers
(including negation). The default exponent is a single number, so whenever division (or
multiplication) of numbers is used, parentheses must be used. Hence:
2 m\hat{ }(1/3) =2 m\hat{ }0.33333
2 m\hat{ }1 /3 = 2 (m\hat{ }1) / 3 = 0.66667 m
2 m\hat{ }(2 * 3) = 2 m\hat{ }6
2 m\hat{ }−1 / s = 2 / m s
2 m\hat{ }2 / 3 s\hat{ }2 = (2 m\hat{ }2) / (3 s\hat{ }2) = 0.666667 m\hat{ }2 / s\hat{ }2
2 m\hat{ }2 /s = 2 m\hat{ }2 / s
2 m\hat{ }2 / 3 = 0.666667 m\hat{ }2
2 m\hat{ }(2/3) = 2 m\hat{ }0.666667
3 / 8 m = 3 / (8 m) = (3/8) * (1/m) = 0.375 / m
(3/8) m = (3/8) m = 0.375 m
Multiplication is allowed in a base units exponent even though it is rarely done. Variables
and mathematical functions cannot be used in base unit exponents.
A dimensionless value (either a scalar or vector) must immediately precede the unit
expression. A space does NOT imply a dimensionless value of one. For example:
kg
returns an error. It needs a dimensionless value before it.
5 / s = 5 s\hat{ }(−1)
1/s = 1 (s\hat{ }(−1)
5 * (1 / s) = 5 / s = 5 s\hat{ }(−1)
5 (1 / s)
returns and error. The space is not implied multiplication for a mathematical expression,
only for a unit expression.

Of these rules, the two that were most often considered for alteration were inserting an implied value of 1.0 (i.e., m=1 m) in front of any unit expression if necessary and allowing 1 to be a base unit (i.e., 5(1/s)). This is straightforward to program, but was rejected for two primary reasons. First, this led to some odd, valid expressions such as “3 1/1 1 m /3”. Second, and more importantly, in our testing, in most cases, a missing or extra 1 was actually a typing mistake that we wanted the invention to catch and inform us about.

That completes the definition of this invention's syntax for mathematical expressions and unit expressions and unambiguously defines how this invention will interpret any input. However, there are still several important syntax rules that this invention uses.

Since this invention must be able to distinguish variable names, mathematical functions names, and dimensional base units, this invention uses the following rules for interpreting text names:

TABLE 15
Syntax rules for base units, mathematical functions,
and variable names.

Dimensional base units are case sensitive. This is required to distinguish
mJ and MJ, for example.
Mathematical functions are not case sensitive. Hence pi( ) = Pi( ) = pI( ) =
PI( ) = 3.14159 . . . None of the mathematical function names match any
dimensional base units.
Variable names are case sensitive and cannot match any base unit or
mathematical function. Otherwise, it would not be clear what was being
referenced. So, for example, t1 = 1 s and T1 = 1 degC. are distinct.
Variable names must begin with an alphabetic character; the other
characters can include all alphanumeric characters and the
underscore “_” symbol.

The most annoying of these rules is that variable names cannot match base units. Hence, “m”, which would be a good variable name for a mass, is not allowed, since it the base unit for meter. We have attempted to strike a balance between recognizing as many common base units as possible while also permitting as many simple variable names as possible. The full list of dimensional base units recognized by this invention is given at the end of this disclosure.

The one letter base units are A, C, D, F, G, g, H, J, L, l, m, N, s, T, and V. Below we list all 55 the one and two letter dimensional base units.

TABLE 16
The list of one and two letter dimensional base
units recognized by this invention.

| | |
|---|---|
| (1) | A |
| (2) | C |
| (3) | cc |
| (4) | cm |
| (5) | cp |
| (6) | D |
| (7) | eV |
| (8) | F |
| (9) | ft |
| (10) | G |
| (11) | g |
| (12) | GJ |
| (13) | GW |
| (14) | H |
| (15) | hp |
| (16) | hz |
| (17) | Hz |
| (18) | in |
| (19) | J |
| (20) | kg |
| (21) | kJ |
| (22) | km |
| (23) | kN |
| (24) | kW |
| (25) | l |
| (26) | L |
| (27) | lb |
| (28) | m |
| (29) | mA |
| (30) | mD |
| (31) | mF |
| (32) | Mg |
| (33) | mg |
| (34) | mi |
| (35) | mJ |
| (36) | MJ |
| (37) | ml |
| (38) | mm |
| (39) | ms |
| (40) | mT |
| (41) | mV |
| (42) | mW |
| (43) | MW |
| (44) | N |
| (45) | nm |
| (46) | Oe |
| (47) | oz |
| (48) | Pa |
| (49) | s |
| (50) | T |
| (51) | V |
| (52) | W |
| (53) | Wb |
| (54) | yd |
| (55) | yr |

We have not include “d”=day and “h”=hour in order to permit these letters to be used as variable names. We have included “mi”=mile, but excluded “Mx”=Maxwell (a good variable name for a moment in the X direction). Because variable names are case sensitive, M, f, and a are valid variable names. Valid variable names can be composed using a letter followed by a number. So, m0, m1, and m2 are valid names for different masses.

This invention recognizes six kinds of functions:
Constants
Common Mathematical Functions
Advanced Mathematical Functions
Vector Functions
Functions of Functions
Other (help and default units)
   All of these functions are case insensitive. Nevertheless, some of the function names are written with capitals when this makes them easier to read and remember or use.

The constants recognized by this invention must be followed by open and closed parentheses, with no arguments.

TABLE 17
The constants recognized by this invention.

Boltzmann( ) = 1.38065e−23 J / degK (Boltzmann constant)
CLight( ) = 299792458.0 m/s (speed of light)
euler( ) = 0.5772156649015328606065120900824024310422
gas( ) = 8.31434 J / mol / degK
GEarth( ) = 6.67428e11 m\hat{ }3 / kg s\hat{ }2 (Earth's gravitational constant)
grav( ) = 9.806652 m / s\hat{ }2
pi( ) = 3.1415926535897932384626433832795028841972
Planck( ) = 6.62606896e−34 kg m\hat{ }2 / s (Planck's constant)
StefanBoltzmann( ) = 5.6704e−8 W / m\hat{ }2 degK\hat{ }4
(Stefan-Boltzmann constant)

The common mathematical functions are:

TABLE 18
The common mathematical functions recognized by this invention.

abs(x) = absolute value of x
acos(x) = arccosine of x
acot(x) = arc cotangent of x
acsc(x) = arc cosecant of x
asec(x) = arc secant of x
asin(x) = arcsine of x
atan(x) = arctangent of x
atan2(y, x) = arctangent in correct quadrant of y/x
ceil(x) = ceiling of x
cos(x) = cosine of x
cosh(x) = hyperbolic cosine of x
cot(x) = cotangent of x
coth(x) = hyperbolic cotangent of x
csc(x) = cosecant of x
csch(x) = hyperbolic cosecant of x
exp(x) = exponential of x
floor(x) = floor of x
int(x) = integer of x
LinInterp(x1, y1, x2, y2, x) = y1 + (x − x1) * (y2 − y1)/(x2 − x1)
ln(x) = natural logarithm of x
log(x) = natural logarithm of x
log10(x)= log base 10 of x
mod(x, y) = floating point remainder of y/x
Normsdist(z) = Standard normal cumulative distribution
(mean = 0, stdev = 1)
Normsinv(z) = Inverse of the standard normal cumulative distribution
(mean = 0, stdev = 1)
Number(x, units) = dimensionless value of x in units
round(x) = nearest integer to x
sec(x) = secant of x
sech(x) = hyperbolic secant of x
sign(x) = sign of x
sin(x) = sine of x
sinh(x) = hyperbolic sine of x
sqrt(x) = square root of x
tan(x) = tangent of x
tanh(x) = hyperbolic tangent of x

For most of these functions, the argument (x) must be dimensionless. The exceptions are the inverse trigonometric functions (which require angles, but see below); a tan 2, which requires two arguments with the same dimensions, LinInterp, where x1, x2, and x must have the same dimensions, and y1 and y2 must have the same dimensions; Number(x, units), which is used to retrieve a dimensionless number for the value of x written in the units expression “units”.

The advanced mathematical functions are:

TABLE 19
The advanced mathematical functions recognized by this invention.

AiryAi(x) = Airy function Ai(x)
AiryBi(x) = Airy function Bi(x)
BesselI(n, x) = Modified Bessel function of the first kind, I(n, x)
BesselJ(n, x) = Bessel function of the first kind, J(n, x)
BesselK(n, x) = Modified Bessel function of the second kind, K(n, x)
BesselY(n, x) = Bessel function of the second kind, Y(n, x)
BetaFunc(z, w) = Beta function B(z, w)
EllipticE(phi, k) = Legendre elliptic integral of the second kind, E(phi, k)
EllipticF(phi, k) = Legendre elliptic integral of the first kind F(phi, k)
EllipticPi(phi, n, k) = Legendre elliptic integral of the third kind,
Pi(phi, n, k)
Erf(x) = Error function, erf(x)
Erfc(x) = Complimentary error function, erfc(x)
ExpInt(x) = Exponential integral E(1,x)
ExpIntEi(x) = Exponential integral Ei(x)
ExpIntN(n,x) = Exponential integral E(n,x)
GammaFunc(x) = Gamma function of x
GammaPFunc(a, x) = Incomplete Gamma function P(a, x)
GammaQFunc(a, x) = Incomplete Gamma function Q(a, x) = 1 − P(a, x)
IncBetaFunc(a, b, x) = Incomplete Beta function I(a, b, x)
JacobiCN(u, kc) = Jacobian elliptic function, cn(u, kc)
JacobiDN(u, kc) = Jacobian elliptic function, dn(u, kc)
JacobiSN(u, kc) = Jacobian elliptic function, sn(u, kc)
LogGammaFunc(x) = Natural log of the gamma function of x

This invention also recognizes vectors of dimensional values. These are defined by listing comma separated components between square brackets. All components of the vector must have the same dimensions, although these can be expressed using any compatible units expression. Note that a vector with dimensionless components is dimensionless, so the entire vector can be assigned units just as with a scalar value. For example:

TABLE 20
Vectors are assigned using square brackets.

| Input: | a = [ 1 in] | |
|---|---|---|
| | b = [2 ft, (3 + 4) in]; m | |
| | c = [5, 6, 7] m/s | |
| | d = [5 m, 4 kg, 0] | |
| Output: | [ 1 ] | a = [ 1 in] |
| | | a = [ 0.0254 , 0 , 0 ] m |
| | [ 2 ] | b = [2 ft, (3 + 4) in]; m |
| | | b = [ 0.6096 , 0.1778 , 0 ] m |
| | [ 3 ] | c = [5, 6, 7] m/s |
| | | c = [ 5 , 6 , 7 ] m / s |
| | [ 4 ] | d = [5 m, 4 kg, 0] |
| | | ERROR: All vector components must have same units. |

This invention recognizes the following functions that operate on vectors:

TABLE 21
The vector functions recognized by this invention.

angle(x, y) = angle between vectors x and y
component(x, n) = the nth component of a vector x
cross(x, y) = cross product of vectors x and y (3 dimensional vectors)
dot(x, y) = dot product of vectors x and y
mag(x) = magnitude of vector x
PolarAngle(x) = atan2(component(x,2), component(x,1))
PolarVec(f, q) = [cos(q), sin(q), 0] * f

In addition, instead of using the component( ) function, one of the components of a vector with a variable name can be accessed simply by following the variable name with square brackets enclosing the component to access. For example,

TABLE 22
Accessing components using the variable name and brackets.

| Input: | x = [ 3, 4, 0] | |
|---|---|---|
| | q = atan2(x[2], x[1]); deg | |
| Output: | [ 1 ] | x = [ 3, 4, 0] |
| | | x = [ 3 , 4 , 0 ] |
| | [ 2 ] | q = atan2(x[2], x[1]); deg |
| | | q = 53.1301 deg |

Many engineering calculations involve solving linear or nonlinear equations, or determining one or more dimensional values that optimize an objective function. This invention can do both of these.

This invention defines a syntax for specifying user-defined functions. A number of programs define functions explicitly in terms of variables. For example, in Microsoft's PowerToy calculator, you can define a dimensionless function by typing “f(x)=x*x”. This creates a function called “f” that uses the variable “x” inside the function. When you call the function, “f(5)”, it will replace “x” with the value “5” and then evaluate the function. Various other programs including Mathematica use similar syntax.

This syntax works for simple, one line mathematical functions but is a poor syntax for dimensional calculations. In many if not most real world calculations, the function computes more than one value that must be displayed. For example, when solving two linear equations for two unknowns, the solution must display both unknowns in whatever output units the user requests. In even moderately complicated problems, there are also auxiliary values that are computed whose value the user would like to know in the requested output units. It is difficult to construct a syntax for a single line that easily allows the different outputs to be displayed to be specified.

Instead, this invention takes advantage of the fact that its input consists of lines of input text. In this invention, only one function can be defined at a time, and the function is defined by whatever input text lies between the commands “BEGIN” and “END”, which are not case sensitive and which must occur on their own lines.

For example, to duplicate the function “f(x)=x*x” defined above, type:

TABLE 23
The Defining the function f(x) = x * x.

| Input: | BEGIN | |
|---|---|---|
| | x = 4 | |
| | f = x * x | |
| | END | |
| Output: | [ 1 ] | BEGIN |
| | [ 1 ] | x = 4 |
| | | x = 4 |
| | [ 2 ] | f = x * x |
| | | f = 16 |
| | [ 3 ] | END |

Notice that an initial value for x must be given, in this case, x=4. This is similar to programming in Excel where cells must be given initial values. This format allows us to define what units, if any, the input values have, how they should be displayed in output, and verify the dimensional consistency of any equations. Of course, in simple, purely mathematical functions, everything is dimensionless so these capabilities are not needed.

To evaluate f(5), we call the function “func(x, 5)” after the function is defined (i.e., after the END line).

TABLE 24
Evaluating f(5).

| Input: | BEGIN | |
|---|---|---|
| | x = 4 | |
| | f = x * x | |
| | END | |
| | func(x, 5) | |
| Output: | [ 1 ] | BEGIN |
| | [ 1 ] | x = 4 |
| | | x = 4 |
| | [ 2 ] | f = x * x |
| | | f = 16 |
| | [ 3 ] | END |
| | [ 4 ] | func(x, 5) |

Func:
[ Func1 ] UPDATED VALUE:

x = 5

[ Func2 ] f = x * x

f = 25

[ Func3 ] END

Once the call to “func” has been read, this invention goes back through and re-evaluates all the input lines between the most recent BEGIN and END. When it encounters any line that defines the value of x, it ignores the input text, prints the words “UPDATED VALUE”, and then gives the specified value of the variable name. Notice that the function value “f” is simply printed out as part of the output. It does not have to be explicitly part of the func(x, 5) call—all lines in the function are re-evaluated and displayed in whatever requested output units needed. The re-evaluated lines are numbered “Func1”, “Func2”, etc. to distinguish them from the input text. If there is input text after the function call, that is evaluated after the function evaluation.

This syntax has several advantages. The lines of code can include and display all the auxiliary calculations associated with the function. In this respect, this is similar to MathCad's “workbook” concept, in which a series of linked calculations can be updated when an input value is changed and all of the outputs can be displayed.

func( ) is one of four functions that manipulate user defined functions. The table below lists the other functions:

TABLE 25
The functions of user-defined functions recognized by This invention.

func(x1, val1, x2, val2, . . .) = evaluate func(x1 = val1, x2 = val2, . . .)
max(y, x1, x2, . . .) = choose x1, x2, . . . to maximize y
min(y, x1, x2, . . .) = choose x1, x2, . . . to minimize y
solve(y1, y2, . . . , x1, x2 . . . ) = choose x1, x2, . . . such that
y1 = y2 = . . . 0

All the arguments for max( ), min( ), and solve( ) must be variable names. They cannot be explicit calculations. In other words, with the simple function above f(x)=x*x, you cannot enter solve(x̂2,x). Also, all function of function arguments must be scalars.

For example, suppose we want to find the minimum of cos(x):

TABLE 26
Finding the minimum of cos(x).

| | |
|---|---|
| Input: | MKS(deg) |
| | BEGIN |
| | x = 5 deg |
| | y = cos(x) |
| | END |
| | min(y, x) |
| Output: | [ 1 ] MKS(deg) |
| | Default units = MKS with 1 exception. |
| | [ 2 ] BEGIN |
| | [ 2 ] x = 5 deg |
| | x = 5 deg |
| | [ 3 ] y = cos(x) |
| | y = 0.996195 |
| | [ 4 ] END |
| | [ 5 ] min(y, x) |
| | Min: |
| | [ Min1 ] UPDATED VALUE: |
| | x = 180 deg |
| | [ Min2 ] y = cos(x) |
| | y = −1 |
| | [ Min3 ] END |

Below, we show a lengthy example in which the static equilibrium solution for a physical system is found by summing the forces and moments and solving to make them all vanish.

Notice that in the solution (lines numbered “Sol1” to “Sol11”, the auxiliary quantities of each force and moment are updated and displayed in the FPS units requested.

TABLE 27
Solving a statics problem using the solve( ) function

| | |
|---|---|
| Input: | FPS |
| | r1 = [−5, −1] in |
| | f1 = [10, −90] lbf |
| | r2 = [2, 3] in |
| | r3 = [0, 0] in |
| | BEGIN |
| | fx = 10 lbf # initial guess |
| | fy = 10 lbf # initial guess |
| | fz = 10 lbf # initial guess |
| | f2 = [fx, fy] |
| | f3 = [fz, 0] |
| | sumf = f1 + f2 + f3 |
| | summ = cross(r1, f1) + cross(r2, f2) + cross(r3, f3) |
| | e1 = sumf[1] |
| | e2 = sumf[2] |
| | e3 = summ[3] |
| | END |
| | solve(e1, e2, e3, fx, fy, fz) |
| Output: | [ 1 ] FPS |
| | Default units = FPS with 0 exceptions. |
| | [ 2 ] r1 = [−5, −1] in |
| | r1 = [ −0.416667 , −0.0833333 , 0 ] ft |
| | [ 3 ] f1 = [10, −90] lbf |
| | f1 = [ 10 , −90 , 0 ] lbf |
| | [ 4 ] r2 = [2, 3] in |
| | r2 = [ 0.166667 , 0.25 , 0 ] ft |
| | [ 5 ] r3 = [0, 0] in |
| | r3 = [ 0 , 0 , 0 ] ft |
| | [ 6 ] BEGIN |
| | [ 6 ] fx = 10 lbf # initial guess |
| | fx = 10 lbf |
| | [ 7 ] fy = 10 lbf # initial guess |
| | fy = 10 lbf |
| | [ 8 ] fz = 10 lbf # initial guess |
| | fz = 10 lbf |
| | [ 9 ] f2 = [fx, fy] |
| | f2 = [ 10 , 10 , 0 ] lbf |
| | [ 10 ] f3 = [fz, 0] |
| | f3 = [ 10 , 0 , 0 ] lbf |
| | [ 11 ] sumf = f1 + f2 + f3 |
| | sumf = [ 30 , −80 , 0 ] lbf |
| | [ 12 ] summ = cross(r1, f1) + cross(r2, f2) + cross(r3, f3) |
| | summ = [ 0 , 0 , 37.5 ] lbf ft |
| | [ 13 ] e1 = sumf[1] |
| | e1 = 30 lbf |
| | [ 14 ] e2 = sumf[2] |
| | e2 = −80 lbf |
| | [ 15 ] e3 = summ[3] |
| | e3 = 37.5 lbf ft |
| | [ 16 ] END |
| | [ 17 ] solve(e1, e2, e3, fx, fy, fz) |
| | Solve: |
| | [ Sol1 ] UPDATED VALUE: |
| | fx = 213.333 lbf |
| | [ Sol2 ] UPDATED VALUE: |
| | fy = 90 lbf |
| | [ Sol3 ] UPDATED VALUE: |
| | fz = −223.333 lbf |
| | [ Sol4 ] f2 = [fx, fy] |
| | f2 = [ 213.333 , 90 , 0 ] lbf |
| | [ Sol5 ] f3 = [fz, 0] |
| | f3 = [ −223.333 , 0 , 0 ] lbf |
| | [ Sol6 ] sumf = f1 + f2 + f3 |
| | sumf = [ 9.58418e−09 , 2.55578e−08 , 0 ] lbf |
| | [ Sol7 ] summ = cross(r1, f1) + cross(r2, f2) + cross(r3, f3) |
| | summ = [ 0 , 0 , 2.94143e−08 ] lbf ft |
| | [ Sol8 ] e1 = sumf[1] |
| | e1 = 9.58418e−09 lbf |
| | [ Sol9 ] e2 = sumf[2] |
| | e2 = 2.55578e−08 lbf |
| | [ Sol10 ] e3 = summ[3] |
| | e3 = 2.94143e−08 lbf ft |
| | [ Sol11 ] END |

We can verify the accuracy of this solution by looking at lines Sol6 and Sol7 in which the sum of the forces and moments are computed. As requested, these are negligible.

Users can debug the function by simply leaving off the last input line (“solve(e1, e2, f10, f20)”) and checking the output for errors. Once the function is correct, simply add the last line and re-submit.

This invention has the help functions:
Help( ) Main help options.
Help(units) Lists all known base units alphabetically.
Help(unitgroups) Lists base units by groups.
Help(func) Lists functions alphabetically.
   For example, the table below show the output to the help( ) command.

TABLE 28
The help( ) function.

| | | |
|---|---|---|
| Input: | help( ) | |
| Output: | Help( ) | Main help options. |
| | Help(units) | Lists all known base units alphabetically. |
| | Help(unitgroups) | Lists base units by groups. |
| | Help(func) | Lists functions alphabetically. |

The syntax rules discussed so far fully determine how this invention interprets dimensional input and performs dimensional calculations. Nevertheless, in many real world situations, things are actually done differently in practice. Or, as in the case of temperature, the one non-affine unit conversion recognized by this invention, they may not be fully defined by the rules of the previous section.

In this section, we review all the special cases and describe how they are handled in this invention. In some cases, these are simply clarifications of the syntax rules of the previous section; in other cases, they require additional rules or exceptions in order to produce the desired, expected results.

This invention assumes that “lb” is “lbf” in any input. This is by far the most common use of “lb”, although occasionally users mean “lbm”, which can be confusing. When lb is used in a dimensionally inconsistent manner, an error message is displayed.

Temperature is always a special case for units conversion for two reasons:
Zero degrees is not the same for all temperature units.
Temperature is used in two distinct ways: sometimes it refers to an absolute temperature (“It is 10 degrees Fahrenheit today”) while other times it refers to a temperature difference, i.e., a relative temperature (“It is 10 degrees Fahrenheit hotter than yesterday”). NOTE: When we use the term absolute, we are not referring to whether the scale is relative to absolute zero, only that it is not a temperature difference.
   The formula for changing degrees Fahrenheit to degrees Celsius is:

deg C.=(5/9)(deg F.−32)

To change the statement “It is 10 degrees Fahrenheit today” into Celsius, the full formula is needed:

(5/9)(10 deg F.−32)=−12.22 deg C.

However, to change the statement “It is 10 degrees Fahrenheit hotter than yesterday”, only the (5/9) part of the formula is used:

(5/9)(10 deg F.diff)=5.556 deg C.diff

This invention has been designed with a special syntax to distinguish these two cases so that it does the conversion intended by the user while keeping the syntax close to common, real world use.

Specifically, this invention distinguishes the case where temperature is a single temperature base unit in the numerator (in which case it assumes an absolute conversion) from all other cases which are assumed to be relative conversion.

For example, in the example below we change absolute temperature. Because the units are all single temperature base units in the numerator, all of these are converted as absolute temperatures.

TABLE 29
A single temperature base unit in the numerator indicates
absolute temperature conversion.

| | |
|---|---|
| Input: | 1 degC; degF; degK; degR |
| Output: | [ 1 ] 1 degC; degF; degK; degR |
| | = 33.8 degF = 274.15 degK = 493.47 degR |

If the single temperature base unit is moved to the denominator, the relative temperature conversion is performed:

TABLE 30
When a single temperature base unit is NOT in the numerator,
relative temperature conversion is performed.

| | |
|---|---|
| Input: | 1 / degC; / degF; degK\hat{ }(−1); degR\hat{ }−1 |
| Output: | [ 1 ] 1 / degC; / degF; degK\hat{ }(−1); degR\hat{ }−1 |
| | = 0.555556 / degF = 1 degK\hat{ }(−1) = 0.555556 degR\hat{ }−1 |

Whenever temperature units are embedded in other units (such as, for example, “J/deg C.”) it is always interpreted as a relative temperature.

Sometimes, a temperature difference (i.e., relative temperature) is needed as an input quantity, such as in the example “It is 10 degrees Fahrenheit hotter than yesterday”. This is not directly possible with the “degF” base units. Instead, this invention defines four relative temperature based units degCdiff, degKdiff, degFdiff, and degRdiff, as illustrated below.

TABLE 31
To input a relative temperature difference using a single base unit
in the numerator, use degCdiff, degKdiff, degFdiff, and degRdiff.

| | |
|---|---|
| Input: | 1 degCdiff; degFdiff; degKdiff; degRdiff |
| Output: | [ 1 ] 1 degCdiff; degFdiff; degKdiff; degRdiff |
| | = 1.8 degFdiff = 1 degKdiff = 1.8 degRdiff |

A real world example using relative temperature is thermal conductivity, where the rate of heat energy conducted through a flat object is proportional to the temperature difference on either side of the object. The example below computes how much thermal energy flows through three inches of insulation.

TABLE 32
Thermal conductivity: a real world example using
relative temperature units.

| | |
|---|---|
| Input: | delT = 21 degCdiff |
| | k = 0.20 J / s m degC |
| | w = 3 in |
| | a = 10 m\hat{ }2 |
| | h = k * a * delT / w; J/s |
| Output: | [ 1 ] delT = 21 degCdiff |
| | delT = 21 degKdiff |
| | [ 2 ] k = 0.20 J / s m degC |
| | k = 0.2 kg m / s\hat{ }3 degK |
| | [ 3 ] w = 3 in |
| | w = 0.0762 m |
| | [ 4 ] a = 10 m\hat{ }2 |
| | a = 10 m\hat{ }2 |
| | [ 5 ] h = k * a * delT / w; J/s |
| | h = 551.181 J/s |

Of course, one could also obtain relative temperature differences by entering two different absolute temperatures and then subtracting them, but this can be cumbersome. In the example above, we could define T1=25 deg C., T2=4 deg C. and then replace delT in the final formula by (T1−T2).

Occasionally a formula uses combinations of absolute temperature. For example, in radiant heat, the formula involves absolute temperature to the fourth power. Because of the exponentiation, this invention will interpret deg C.̂4 as a relative temperature. This invention does not provide a method for combined, absolute temperature conversion. Instead, the absolute temperature should be input in deg C. as a distinct input, and then the combination (raising to the fourth power in this case) should be done as a separate formula calculation. The example below computes the net heat flow due to radiation from a person standing in room temperature air:

TABLE 33
To use absolute temperatures in a formula such as thermal radiation,
enter any temperatures as separate variables.

| | |
|---|---|
| Input: | T_person = 98.6 degF |
| | T_air = 72 degF |
| | a = 1.5m\hat{ }2 # surface area |
| | e = 0.70 # emissivity |
| | h = e * StefanBoltzmann( ) * a * (T_person\hat{ }4 − T_air\hat{ }4); W |
| Output: | [ 1 ] T_person = 98.6 degF |
| | T_person = 310.15 degK |
| | [ 2 ] T_air = 72 degF |
| | T_air = 295.372 degK |
| | [ 3 ] a = 1.5m\hat{ }2 # surface area |
| | a = 1.5 m\hat{ }2 |
| | [ 4 ] e = 0.70 # emissivity |
| | e = 0.7 |
| | [ 5 ] h = e * StefanBoltzmann( ) * a * |
| | (T_person\hat{ }4 − T_air\hat{ }4); W |
| | h = 97.7307 W |

Because this invention was designed to do as much of the unit conversion as possible in dimensional calculations, radians and other angular measurements cannot simply be treated as a dimensionless number.

Formally, a radian is dimensionless, and the simplest and most common method of handling radians, degrees, and revolutions is to treat them as dimensionless values. For example, on many hand calculators, when you enter

sin(45)

the calculator defaults to interpret this as sin(45 radians), unless the user selects an option to have all arguments to trigonometric functions default to degrees. However, practical problems arise with this approach as soon as other units are considered because in the real world angular measurement is often not simply interpreted as a dimensionless number.

First, if radians are truly dimensionless, then it is impossible to distinguish circular frequency (radians per second) from linear frequency (inverse seconds) because these two units are identical. When using circular frequency in calculations, rather than having this invention take care of the units for the user, the user would be responsible for explicitly inserting appropriate values of 2π whenever necessary. This is undesirable.

Second, if one of the default output units is degrees, then, all dimensionless numbers would be converted to degrees, including ones that have no angular interpretation. This would be very confusing. In fact, if this approach were taken, then we would have to create a new base unit for true dimensionless numbers so that users could explicitly override a default such as degrees.

For these reasons, this invention treats angular measurement as a distinct unit even though this is “formally” incorrect. This solves the above two problems.

Of course, this also means that this invention thinks sin(45) and sin(45 rad) have different arguments. However, by default, this invention accepts either a dimensionless number or an angular argument for all trigonometric functions, so both sin(45) and sin(45 rad) give the same answer.

The approach just described works well in practice, but some exceptions arise. Occasionally, formulas are used which explicitly utilize the fact that radians are formally dimensionless numbers. For example, occasionally one runs across formulas such as

x=2 rad

y=x+sin(x)

If this invention followed the formal syntax, then it would not allow the addition of an angular value (x) and a dimensionless number (sin(x)). However, since this is not the expected result for most users, this invention allows this, and returns a value that is dimensionless.

Notice in the example below that y0 and y1 are returned as dimensionless numbers, not numbers with angular units (e.g., rad).

TABLE 34
Example illustrating how angular units and dimensionless
numbers can be combined.

| | |
|---|---|
| Input: | x0 = 3 |
| | y0 = x0 + sin(x0) |
| | x1 = 1 rad |
| | y1 = x1 + sin(x1) |
| Output: | [ 1 ] x0 = 3 |
| | x0 = 3 |
| | [ 2 ] y0 = x0 + sin(x0) |
| | y0 = 3.14112 |
| | [ 3 ] x1 = 1 rad |
| | x1 = 1 rad |
| | [ 4 ] y1 = x1 + sin(x1) |
| | y1 = 1.84147 |
| | [ 5 ] y1 = x1 + sin(x1) |
| | y1 = 1.84147 |

One of the well known and frequently used calculations is to multiply circular frequency by a radius to obtain linear velocity. This is just one of a class of problems in which a dimensional value with units incorporating radians is multiplied by a dimensional value that incorporates length units. In these cases, it is customary to strip the radians from the result (i.e., treat radians as a truly dimensionless unit). Because this operation occurs so frequently, this has been programmed into this invention.

TABLE 35
Example multiplication of angular measurements by length.

| | |
|---|---|
| Input: | om = 50000 rpm |
| | r = 6 cm |
| | v = om * r |
| | a = v\hat{ }2 / r |
| Output: | [ 1 ] om = 50000 rpm |
| | om = 5235.99 rad / s |
| | [ 2 ] r = 6 cm |
| | r = 0.06 m |
| | [ 3 ] v = om * r |
| | v = 314.159 m / s |
| | [ 4 ] a = v\hat{ }2 / r |
| | a = 1.64493e+006 m / s\hat{ }2 |

In the example above, the resulting values for “v” and “a” do not include radians.

As discussed previously, this invention explicitly distinguishes circular frequency (radians per second) and linear frequency (inverse seconds). Because of this, there are several base units which also incorporate this distinction.

The two base units for circular frequency (radians per second) are:
rps=revolutions (or rotations) per second
rpm=revolutions (or rotations) per minute
   The base units for linear frequency (inverse seconds) are
Hz=Hertz=inverse seconds
kHz=kilohertz
MHz=megahertz
GHz=gigaHertz
   The user should be careful not to confuse rps and Hz, as they are not the same in this invention.

The number zero is special: one can argue that the number zero has all dimensions, or no dimensions, or something in between. However, in an application such as this invention, it definitely has a unique set of dimensions associated with it, just like all values.

However, when inputting vectors, all of whose components must have compatible units, it is often convenient to assume that any zeros have whatever the appropriate units are to make the vector correct. This only applies to zero as an argument in a vector.

TABLE 36
Example using zeros when inputting vectors.

| | |
|---|---|
| Input: | f1 = [0, 2 lbf, 0] |
| | f2 = [1, 2 lbf, 0] |
| Output: | [ 1 ] f1 = [0, 2 lbf, 0] |
| | f1 = [ 0 , 8.89644 , 0 ] kg m / s\hat{ }2 |
| | [ 2 ] f2 = [1, 2 lbf, 0] |
| | ERROR: All vector components must have same units. |

This invention uses a tolerance value of 10e−5 when comparing exponents on units so that m̂(1/3) is the same as m̂(0.33333) but not m̂(1/3) is not equal to m̂(0.3).

TABLE 37
Example illustrating tolerance for non-integer exponents.

| | |
|---|---|
| Input: | 5 m\hat{ }(1/3); m\hat{ }(0.33333); m\hat{ }(0.3) |
| Output: | [ 1 ] 5 m\hat{ }(1/3); m\hat{ }(0.33333); m\hat{ }(0.3) |
| | ERROR IN REQUESTED OUTPUT: ‘m\hat{ }(0.3)’ is |
| | incompatible. |
| | = 5 m\hat{ }(0.33333) |

The Number function creates a dimensionless value from a dimensional value. For example, to extract the dimensionless value of a length measurement in cm,

TABLE 38
Example illustrating the Number function.

| | |
|---|---|
| Input: | x = 2 ft |
| | y = Number(x, cm) |
| Output: | [ 1 ] x = 2 ft |
| | x = 0.6096 m |
| | [ 2 ] y = Number(x, cm) |
| | y = 60.96 |

The following is a list of base units recognized by this invention:

TABLE 39
A list of pre-programmed base units recognized by this invention.

| | | |
|---|---|---|
| 1% = | 0.01 | |
| 1 A = | 1 | C/s |
| 1 acre = | 4046.86 | m\hat{ }2 |
| 1 amp = | 1 | C/s |
| 1 ampere = | 1 | C/s |
| 1 angstrom = | 1e−010 | m |
| 1 atm = | 101325 | kg/s\hat{ }2 m |
| 1 atmosphere = | 101325 | kg/s\hat{ }2 m |
| 1 bar = | 100000 | kg/s\hat{ }2 m |
| 1 barrel = | 0.158987 | m\hat{ }3 |
| 1 boardfoot = | 0.00235974 | m\hat{ }3 |
| 1 BritishThermalUnit = | 1055.06 | kg m\hat{ }2/s\hat{ }2 |
| 1 BTU = | 1055.06 | kg m\hat{ }2/s\hat{ }2 |
| 1 Btu = | 1055.06 | kg m\hat{ }2/s\hat{ }2 |
| 1 btu = | 1055.06 | kg m\hat{ }2/s\hat{ }2 |
| 1 bushel = | 0.0352391 | m\hat{ }3 |
| 1 C = | 1 | C |
| 1 cal = | 4.1868 | kg m\hat{ }2/s\hat{ }2 |
| 1 carat = | 0.0002 | kg |
| 1 cc = | 1e−006 | m\hat{ }3 |
| 1 centimeter = | 0.01 | m |
| 1 centipoise = | 0.001 | kg/s m |
| 1 centistoke = | 1e−006 | m\hat{ }2/s |
| 1 cm = | 0.01 | m |
| 1 cmHg = | 1333.22 | kg/s\hat{ }2 m |
| 1 cmWater = | 98.0638 | kg/s\hat{ }2 m |
| 1 cord = | 3.62456 | m\hat{ }3 |
| 1 coulomb = | 1 | C |
| 1 cp = | 0.001 | kg/s m |
| 1 cubit = | 0.457201 | m |
| 1 cup = | 0.000236588 | m\hat{ }3 |
| 1 D = | 9.8692e−013 | m\hat{ }2 |
| 1 darcy = | 9.8692e−013 | m\hat{ }2 |
| 1 day = | 86400 | s |
| 1 deg = | 0.0174533 | rad |
| 1 degC = | 274.15 | degK |
| 1 degCdiff = | 1 | degKdiff |
| 1 degF = | 255.928 | degK |
| 1 degFdiff = | 0.555556 | degKdiff |
| 1 degK = | 1 | degK |
| 1 degKdiff = | 1 | degKdiff |
| 1 degR = | 0.555556 | degK |
| 1 degRdiff = | 0.555556 | degKdiff |
| 1 degree = | 0.0174533 | rad |
| 1 dyne = | 1e−005 | kg m/s\hat{ }2 |
| 1 erg = | 1e−007 | kg m\hat{ }2/s\hat{ }2 |
| 1 eV = | 1.60218e−019 | kg m\hat{ }2/s\hat{ }2 |
| 1 F = | 1 | s\hat{ }2 C\hat{ }2/kg m\hat{ }2 |
| 1 farad = | 1 | s\hat{ }2 C\hat{ }2/kg m\hat{ }2 |
| 1 fathom = | 1.8288 | m |
| 1 feet = | 0.3048 | m |
| 1 fluidounce = | 2.95735e−005 | m\hat{ }3 |
| 1 foot = | 0.3048 | m |
| 1 fpm = | 0.00508 | m/s |
| 1 fps = | 0.3048 | m/s |
| 1 ft = | 0.3048 | m |
| 1 G = | 0.0001 | kg/s C |
| 1 g = | 0.001 | kg |
| 1 gal = | 0.00378541 | m\hat{ }3 |
| 1 gallon = | 0.00378541 | m\hat{ }3 |
| 1 gauss = | 0.0001 | kg/s C |
| 1 GHz = | 1e+009 | /s |
| 1 GJ = | 1e+009 | kg m\hat{ }2/s\hat{ }2 |
| 1 GPa = | 1e+009 | kg/s\hat{ }2 m |
| 1 Gpa = | 1e+009 | kg/s\hat{ }2 m |
| 1 Gpsi = | 6.89476e+012 | kg/s\hat{ }2 m |
| 1 grain = | 6.47989e−005 | kg |
| 1 gram = | 0.001 | kg |
| 1 GW = | 1e+009 | kg m\hat{ }2/s\hat{ }3 |
| 1 H = | 1 | kg m\hat{ }2/C\hat{ }2 |
| 1 hectare = | 10000 | m\hat{ }2 |
| 1 henry = | 1 | kg m\hat{ }2/C\hat{ }2 |
| 1 Hertz = | 1 | /s |
| 1 horsepower = | 745.7 | kg m\hat{ }2/s\hat{ }3 |
| 1 hour = | 3600 | s |
| 1 hp = | 745.7 | kg m\hat{ }2/s\hat{ }3 |
| 1 hr = | 3600 | s |
| 1 Hz = | 1 | /s |
| 1 hz = | 1 | /s |
| 1 in = | 0.0254 | m |
| 1 inch = | 0.0254 | m |
| 1 inHg = | 3376.85 | kg/s\hat{ }2 m |
| 1 inWater = | 248.84 | kg/s\hat{ }2 m |
| 1 J = | 1 | kg m\hat{ }2/s\hat{ }2 |
| 1 kcal = | 4186.8 | kg m\hat{ }2/s\hat{ }2 |
| 1 kg = | 1 | kg |
| 1 kgf = | 9.80665 | kg m/s\hat{ }2 |
| 1 kHz = | 1000 | /s |
| 1 kilogram = | 1 | kg |
| 1 kilometer = | 1000 | m |
| 1 kip = | 4448.22 | kg m/s\hat{ }2 |
| 1 kJ = | 1000 | kg m\hat{ }2/s\hat{ }2 |
| 1 km = | 1000 | m |
| 1 kmol = | 1000 | mol |
| 1 kN = | 1000 | kg m/s\hat{ }2 |
| 1 knot = | 0.514444 | m/s |
| 1 kPa = | 1000 | kg/s\hat{ }2 m |
| 1 kpa = | 1000 | kg/s\hat{ }2 m |
| 1 kph = | 0.277778 | m/s |
| 1 KrWavelength = | 6.0578e−007 | m |
| 1 ksi = | 6.89476e+006 | kg/s\hat{ }2 m |
| 1 kW = | 1000 | kg m\hat{ }2/s\hat{ }3 |
| 1 L = | 0.001 | m\hat{ }3 |
| 1 l = | 0.001 | m\hat{ }3 |
| 1 lb = | 4.44822 | kg m/s\hat{ }2 |
| 1 lbf = | 4.44822 | kg m/s\hat{ }2 |
| 1 lbm = | 0.453592 | kg |
| 1 league = | 5556 | m |
| 1 lightyear = | 9.46055e+015 | m |
| 1 liter = | 0.001 | m\hat{ }3 |
| 1 m = | 1 | m |
| 1 mA = | 0.001 | C/s |
| 1 maxwell = | 1e−008 | kg m\hat{ }2/s C |
| 1 mD = | 9.8692e−016 | m\hat{ }2 |
| 1 meter = | 1 | m |
| 1 mF = | 0.001 | s\hat{ }2 C\hat{ }2/kg m\hat{ }2 |
| 1 Mg = | 1000 | kg |
| 1 mg = | 1e−006 | kg |
| 1 MHz = | 1e+006 | /s |
| 1 mi = | 1609.34 | m |
| 1 microamp = | 1e−006 | C/s |
| 1 microfarad = | 1e−006 | s\hat{ }2 C\hat{ }2/kg m\hat{ }2 |
| 1 micron = | 1e−006 | m |
| 1 microvolt = | 1e−006 | kg m\hat{ }2/s\hat{ }2 C |
| 1 mil = | 2.54e−005 | m |
| 1 mile = | 1609.34 | m |
| 1 milliamp = | 0.001 | C/s |
| 1 millibar = | 100 | kg/s\hat{ }2 m |
| 1 millidarcy = | 9.8692e−016 | m\hat{ }2 |
| 1 millifarad = | 0.001 | s\hat{ }2 C\hat{ }2/kg m\hat{ }2 |
| 1 milligram = | 1e−006 | kg |
| 1 milliliter = | 1e−006 | m\hat{ }3 |
| 1 millimeter = | 0.001 | m |
| 1 millipoise = | 0.0001 | kg/s m |
| 1 millisecond = | 0.001 | s |
| 1 millivolt = | 0.001 | kg m\hat{ }2/s\hat{ }2 C |
| 1 min = | 60 | s |
| 1 minute = | 60 | s |
| 1 MJ = | 1e+006 | kg m\hat{ }2/s\hat{ }2 |
| 1 mJ = | 0.001 | kg m\hat{ }2/s\hat{ }2 |
| 1 ml = | 1e−006 | m\hat{ }3 |
| 1 mm = | 0.001 | m |
| 1 mmHg = | 133.322 | kg/s\hat{ }2 m |
| 1 MN = | 1e+006 | kg m/s\hat{ }2 |
| 1 mol = | 1 | mol |
| 1 mole = | 1 | mol |
| 1 MPa = | 1e+006 | kg/s\hat{ }2 m |
| 1 Mpa = | 1e+006 | kg/s\hat{ }2 m |
| 1 mPa = | 0.001 | kg/s\hat{ }2 m |
| 1 mpa = | 0.001 | kg/s\hat{ }2 m |
| 1 mph = | 0.44704 | m/s |
| 1 Mpsi = | 6.89476e+009 | kg/s\hat{ }2 m |
| 1 msec = | 0.001 | s |
| 1 mT = | 0.001 | kg/s C |
| 1 mV = | 0.001 | kg m\hat{ }2/s\hat{ }2 C |
| 1 MW = | 1e+006 | kg m\hat{ }2/s\hat{ }3 |
| 1 mW = | 0.001 | kg m\hat{ }2/s\hat{ }3 |
| 1 N = | 1 | kg m/s\hat{ }2 |
| 1 nanofarad = | 1e−009 | s\hat{ }2 C\hat{ }2/kg m\hat{ }2 |
| 1 nanometer = | 1e−009 | m |
| 1 Newton = | 1 | kg m/s\hat{ }2 |
| 1 newton = | 1 | kg m/s\hat{ }2 |
| 1 nm = | 1e−009 | m |
| 1 Nmile = | 5556 | m |
| 1 Oe = | 79.5775 | C/s m |
| 1 oersted = | 79.5775 | C/s m |
| 1 ohm = | 1 | kg m\hat{ }2/s C\hat{ }2 |
| 1 ounce = | 0.278014 | kg m/s\hat{ }2 |
| 1 oz = | 0.278014 | kg m/s\hat{ }2 |
| 1 ozf = | 0.278014 | kg m/s\hat{ }2 |
| 1 ozm = | 0.0283495 | kg |
| 1 Pa = | 1 | kg/s\hat{ }2 m |
| 1 Pascal = | 1 | kg/s\hat{ }2 m |
| 1 peck = | 0.00880977 | m\hat{ }3 |
| 1 Percent = | 0.01 | |
| 1 percent = | 0.01 | |
| 1 pint = | 0.000473176 | m\hat{ }3 |
| 1 poise = | 0.1 | kg/s m |
| 1 poiseuille = | 1 | kg/s m |
| 1 pound = | 4.44822 | kg m/s\hat{ }2 |
| 1 psf = | 47.8803 | kg/s\hat{ }2 m |
| 1 psi = | 6894.76 | kg/s\hat{ }2 m |
| 1 quart = | 0.000946353 | m\hat{ }3 |
| 1 rad = | 1 | rad |
| 1 radian = | 1 | rad |
| 1 rev = | 6.28319 | rad |
| 1 revolution = | 6.28319 | rad |
| 1 reyn = | 6894.76 | kg/s m |
| 1 reynold = | 6894.76 | kg/s m |
| 1 rpm | 0.10472 | rad/s |
| 1 rps = | 6.28319 | rad/s |
| 1 s = | 1 | s |
| 1 sec = | 1 | s |
| 1 second = | 1 | s |
| 1 slug = | 14.5939 | kg |
| 1 stere = | 1 | m\hat{ }3 |
| 1 stoke = | 0.1 | m\hat{ }2/s |
| 1 stone = | 6.35029 | kg |
| 1 T = | 1 | kg/s C |
| 1 Tablespoon = | 1.47868e−005 | m\hat{ }3 |
| 1 tablespoon = | 1.47868e−005 | m\hat{ }3 |
| 1 Tbs = | 1.47868e−005 | m\hat{ }3 |
| 1 teaspoon = | 4.92892e−006 | m\hat{ }3 |
| 1 tesla = | 1 | kg/s C |
| 1 ton = | 1016.05 | kg |
| 1 tonne = | 1000 | kg |
| 1 Torr = | 133.322 | kg/s\hat{ }2 m |
| 1 torr = | 133.322 | kg/s\hat{ }2 m |
| 1 tsp = | 4.92892e−006 | m\hat{ }3 |
| 1 V = | 1 | kg m\hat{ }2/s\hat{ }2 C |
| 1 volt = | 1 | kg m\hat{ }2/s\hat{ }2 C |
| 1 W = | 1 | kg m\hat{ }2/s\hat{ }3 |
| 1 Watt = | 1 | kg m\hat{ }2/s\hat{ }3 |
| 1 watt = | 1 | kg m\hat{ }2/s\hat{ }3 |
| 1 Wb = | 1 | kg m\hat{ }2/s C |
| 1 weber = | 1 | kg m\hat{ }2/s C |
| 1 week = | 604800 | s |
| 1 yard = | 0.9144 | m |
| 1 yd = | 0.9144 | m |
| 1 year = | 3.15569e+007 | s |
| 1 yr = | 3.15569e+007 | s |

It will be recognized that the invention may be suitably applied to other environments consistent with that described in the present disclosure. In particular:
The current platform could be used for financial calculations. In this context, some of the essential base units would be one or more currencies (US dollars, British pounds, etc.), geometrical returns over various time windows, and volatilities describing the variances of returns over various time window. Pre-defined functions would compute, for instance, the Black-Scholes price of an option given the current stock price, the strike price, the maturities, interest rate, dividend rate, and the kind of option (put and call).
The current platform could have additional functions to correctly handle dimensional vectors and matrices and to perform calculations on matrices and vectors. For example, one could input and solve systems of linear equations explicitly using matrix inversion or pseudo-inversion if necessary. Linear regression on such vectors of dimensional inputs, which could return vectors whose components all had different units, could be implemented.
The current platform can be extended to allow input to be read directly from files. This would allow large data sets, vectors, and matrices to be saved in a file and easily input into the invention without having to carefully copy the data into the input tab.

In comparison with the prior art, the present invention enjoys a number of key features and advantages:
The invention allows a single input value to be converted to two or more different output units using a single line of input.
The invention allows users to input dimensional equations manipulating dimensional values, variables, and functions; the invention checks the equations for dimensional consistency; if the equation is dimensionally consistent and correct, the invention outputs the correct answer; and if the output if not dimensionally consistent or correct, the invention outputs a clear error message indicating the error.
All input and output to the invention is in a format so that it can be copied and pasted as unformatted text (ASCII characters) in general purpose computer applications such as Microsoft Notepad and various email programs. The unformatted input can be copied and pasted directly into the invention as is to produce correct output.
Editable, multi-line unformatted text input that can be used to define and correctly perform dimensional computations.
This invention saves the input and output (as unformatted text) in separate windows. Because this data persist, the user can easily toggle between the input and output so as to edit, revise, improve, or correct the input and then re-submit the new input for calculation.
The invention also allows users to specify units for all output values. The invention performs the same error checking on the output units as well and gives error messages when the requested output units are inconsistent with the dimensional output values.
It is easy to use, both for simple and complicated computations.
The syntax of the input, both for groups of base units and for defining mathematical formulas, is as close to real world usage as possible. There are no special characters or key strokes needed to unambiguously enter any dimensional equation or units conversion.
All input syntax has been kept as simple as possible so that as little typing as possible is required to use the tool.
Apart from indicating the dimensional units of all input quantities and requesting any non-default, desired output units, the user need not worry about units. The invention correctly does all necessary conversions.
Whenever there are any errors or inconsistencies with the units requested, the tool provide clear error messages indicating the nature of the problem. We have made it as hard as possible to make a mistake in this tool and not know about it.
Since all input is saved in the window under the Input tab, whenever any errors occur, they can be easily and quickly corrected and the problem re-submitted. The user can also alter input parameters and quickly re-do the entire computation. This is enormously valuable in areas such as detailed engineering design which is often performed by iteratively adjusting parameters and then re-assessing the impact of these changes.
Since all input is in ASCII characters, you can easily save and exchange your work. The input and output are not encoded in any markup language such as html or XML, nor do they require any special software to read or print out. Furthermore, since the input and output do not have any special characters or key strokes embedded in them, they are unambiguous to all users.
Since the program is deployable through the internet, access to the tool is accessible to any user with an internet connection and an internet browser.
Unlike programs like Excel, all equations are visible in the input and the output, so it is easy to check and debug the input. In Excel, the equations can only be viewed by selecting an individual cell. This makes Excel programs tedious and difficult to debug.
Unlike MathCad, when the output is in error, an error message is returned rather than altering the units of the output to be correct, which may or may not be noticed by the user, and which may or may not match the user's intention.
This invention allows multiple lines of ASCII input which may be performed in sequence to make complicated computations easily to compute.
This invention has two separate windows, and input window and an output window. This allows the input to be preserved and edited quickly and recomputed when mistakes are reported in the output window.

While the present invention has been disclosed in the context of various aspects of presently preferred embodiments, it will be recognized that the invention may be suitably applied to other environments consistent with the claims which follow.

We claim:

1. A computer-implemented method for performing dimensional computations, the method comprising:
entering a mathematical formula to be computed that can use both dimensional values and variable names representing dimensional values;
checking to see if the dimensional values and the equation are dimensionally consistent;
displaying as output either the dimensional value computed by the formula or an error message indicating the dimensional inconsistency encountered in the input.

2. The method of claim 1 where all input and output to the method is in a format so that it can be copied and pasted as unformatted text (ASCII characters) in general purpose computer applications.

3. The method of claim 2 where the input also contains one or more desired units for the output to be displayed in, which is also checked for dimensional consistency, and the output is displayed using those units or is an error message indicating the dimensional inconsistency encountered.

4. The method of claim 3 where all input and output to the invention persists in separate computer windows so that the user can easily toggle between the input and output in order to edit the input to revise and correct the computation being performed.

5. A computer-implemented system for performing dimensional computations, the system comprising:
a memory for storing a mathematical formula to be computed that can use both dimensional values and variable names representing dimensional values;
a processor cooperating with the memory and with software to operate so as to check the equation for dimensional consistency and compute the value of the formula and displaying as output either the dimensional value computed by the formula or an error message indicating the dimensional inconsistency encountered in the input.

6. The computer-implemented system of claim 5 where all input and output to the invention is in a format so that it can be copied and pasted as unformatted text (ASCII characters) in general purpose computer applications.

7. The computer-implemented system of claim 6 where the input also contains one or more desired units for the output to be displayed in, which is also checked for dimensional consistency, and the output is displayed using those units or is an error message indicating the dimensional inconsistency encountered.

8. The computer-implemented system of claim 7 where all input and output to the invention persists in separate computer windows so that the user can easily toggle between the input and output windows, and edit the input to revise and correct the computation being performed.

9. A computer-implemented method for converting a dimensional, numerical value from one unit to two or more alternative dimensional units, the method comprising:
entering an input dimensional, numerical value and its units followed by a character separator;
entering at least two desired, dimensional output units as strings of text characters separated by a character separator on the same input line as the input dimensional value;
computing and displaying either the dimensional, numerical value of the input dimensional numerical value in each desired output units or an error message indicating any dimensional inconsistencies encountered.

10. The method of claim 9 where all input and output to the method is in a format so that it can be copied and pasted as unformatted text (ASCII characters) in general purpose computer applications.

11. The method of claim 10 where all input and output to the invention persists in separate computer windows so that the user can easily toggle between them, and edit the input to revise and correct the computation being performed.
